(19) United States
(12) Patent Application Publication
(10) Pub. No.: US 2023/0029669 A1
(43) Pub. Date: Feb. 2, 2023

(54) SYSTEM FOR MEASURING PIVOT ANGLE OF SHAVER HEAD AND RELATED METHODS

(71) Applicant: BIC Violex Single Member S.A., Anoixi (GR)

(72) Inventors: Georgios GEORGAKIS, Anoixi (GR); Eirini TOUMPEKI, Anoixi (GR); Georgios GOUDELIS, Anoixi (GR)

(73) Assignee: BIC Violex Single Member S.A., Anoixi (GR)

(21) Appl. No.: 17/756,854

(22) PCT Filed: Feb. 12, 2020
(86) PCT No.: PCT/EP2020/053645

§ 371 Date: Jun. 3, 2022

(51) Int. Cl. B26B 21/40; B26B 21/52

(52) U.S. Cl. CPC B26B 21/4056; B26B 21/521; B26B 21/4087

(57) ABSTRACT

A shaving system, comprising a shaver including a handle a cartridge having at least one blade, the cartridge pivotably connected to the handle about a transverse axis of the handle; and a biasing element connected to the handle and connected to the cartridge, the biasing element being configured to move along a longitudinal axis of the handle in response to the cartridge pivoting about; a sensor configured to determine a pivot angle of the shaver cartridge relative to the handle; and a processor configured to receive information about the movement of the biasing element and determine an angle between the cartridge and the handle about the transverse axis based on the information.

### TECHNICAL FIELD

Aspects of the present disclosure relate generally to shaving technology, and, specifically, to embodiments of shavers with sensors for determining a pivot angle of a shaver cartridge relative to, e.g., a handle for, among other things, determining the shaving behaviors of a user. Additional aspects of this disclosure are drawn to methods for providing a customized shaving experience (via e.g., recommendations for cartridge pivot angle alterations) based on, e.g., the cartridge pivot angle and/or a time spent at the pivot angle.

### DESCRIPTION OF RELATED TECHNOLOGY

Shavers generally include a handle and a cartridge releasably attached to one end of the handle. The cartridge includes at least one blade for cutting hairs. A user holds the handle and repeatedly moves the blade across an area of the body to be shaved to cut the hairs in the area. Lubricating material may often be used to help hydrate and protect the skin of a user during shaving. Insufficient or improper lubrication, inappropriate blade type or blade angle, dull or over-used blades, and/or improper technique during shaving may result in undesirable skin irritation and/or nicks and cuts.

### BRIEF DESCRIPTION OF THE DRAWINGS

The accompanying drawings, which are incorporated in and constitute a part of this disclosure, illustrate various embodiments and together with the description, serve to explain the principles of the disclosure.

Aspects of the disclosure may be implemented in connection with embodiments illustrated in the attached drawings. These drawings show different aspects of the present disclosure and, where appropriate, reference numerals illustrating like structures, components, materials, and/or elements in different figures are labeled similarly. It is understood that various combinations of the structures, components, and/or elements, other than those specifically shown, are contemplated and are within the scope of the present disclosure. There are many aspects and embodiments described herein. Those of ordinary skill in the art will readily recognize that the features of a particular aspect or embodiment may be used in conjunction with the features of any or all of the other aspects or embodiments described in this disclosure.

FIG. 1 depicts a shaving system, according to aspects of the present disclosure;

FIG. 2 depicts a shaver, according to aspects of the present disclosure;

FIG. 3 depicts a cross-section of a portion of a shaver, according to aspects of the present disclosure; and

FIG. 4 depicts a flowchart of a method for alerting a user of a shaving condition, according to aspects of the present disclosure.

### DETAILED DESCRIPTION

Both the foregoing general description and the following detailed description are exemplary and explanatory only and are not restrictive of the features, as claimed. As used herein, the terms “comprises,” “comprising,” or other variations thereof, are intended to cover a non-exclusive inclusion such that a process, method, article, or apparatus that comprises a list of elements does not include only those elements but may include other elements not expressly listed or inherent to such a process, method, article, or apparatus. Additionally, the term “exemplary” is used herein in the sense of “example,” rather than “ideal.” It should be noted that all numeric values disclosed or claimed herein (including all disclosed values, limits, and ranges) may have a variation of +/−10% (unless a different variation is specified) from the disclosed numeric value. Moreover, in the claims, values, limits, and/or ranges mean the value, limit, and/or range +/−10%.

Reference will now be made in detail to the aspects of the present disclosure described below and illustrated in the accompanying drawings. Wherever possible, the same reference numbers will be used throughout the drawings to refer to same or like parts.

Additional objects and advantages of the disclosed aspects will be set forth in part in the description that follows, and in part will be readily apparent from the description or may be learned by practice of the embodiments. It is to be understood that both the foregoing general description and the following detailed description are explanatory only and are not restrictive of the claims.

Embodiments of the present disclosure may promote better shaving experiences by creating a more efficient and enjoyable shaving session for a multitude of users by informing users of optimal shaving techniques.

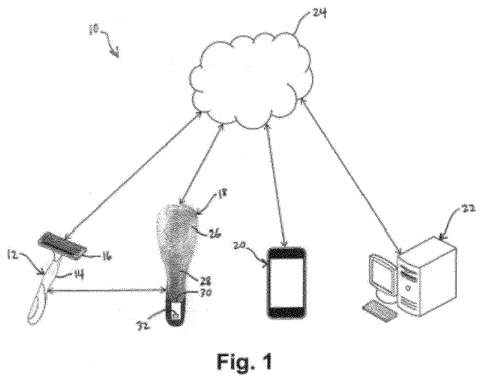

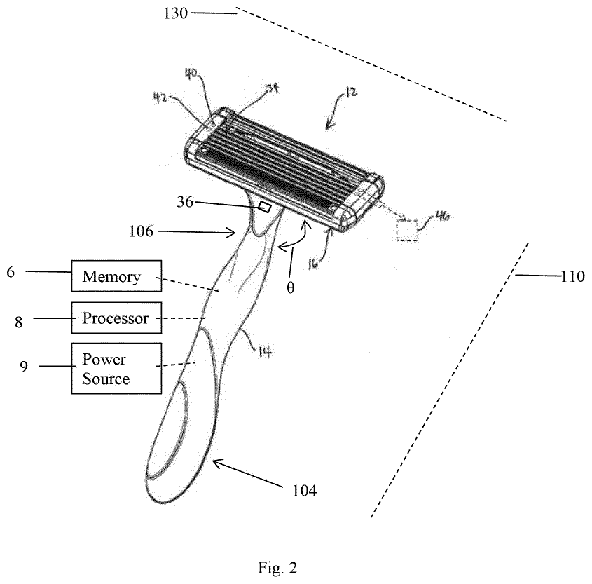

A shaving system 10 according to the instant disclosure is shown in FIG. 1. The shaving system 10 may be configured to identify a shaving condition, and facilitate and promote efficient shaving techniques for an improved shaving experience via, e.g., recommendations or other feedback provided to the user. Shaving system 10 may include a shaver 12 having a handle 14 and a cartridge 16 releasably attached thereto, a base 18, a user device 20, and a merchant unit 22. Each of shaver 12, base 18, user device 20, and merchant unit 22 may be in operative communication with one or more of the other components. The communication may entail transmitting and receiving data signals through wired or wireless connections such as, for example, through a Bluetooth™ connection, AirDrop™, wired and/or wireless internet, and/or any other suitable connection 24. It is also contemplated that one or more of shaver 12, base 18, user device 20, and merchant unit 22 may include a memory element (e.g., memory 6 on shaver 12 shown in FIG. 2) to store information, a processor (e.g., processor 8 on shaver 12 shown in FIG. 2) to process information, and a power source (e.g., power source 9 on shaver 12 shown in FIG. 2), such as a battery and/or an external plug for an outlet, to power electronic components and devices therein.

Handle 14 of shaver 12 may be removably coupled to base 18 by, for example, a snap-fit, latching, or locking mechanism 26 that removably secures handle 14 to base 18 between uses, during travel, and/or during shipment from a merchant or a manufacturer. Furthermore, base 18 may include a handle mount 28, which may include either a wired or a wireless charging apparatus (e.g., electrodes or an inductive coil) for any electronic elements in handle 14.

Base 18 may also include a display 30. Display 30 may be any suitable display, including, but not limited to, a liquid crystal display (LCD) unit. Display 30 may visually or graphically display information to the user, for example, user information, recommendations for shaver 12, feedback or other educational or informative content, and/or shaving or other usage suggestions. The displayed information may be based on the data or information received from sensors associated with shaver 12 or otherwise received from the user, e.g., via manual user input. Alternatively, or additionally, base 18 may audibly provide information to the user via a speaker.

Base 18 may solicit or otherwise request input or feedback from a user via, e.g., display 30. For example, information may be displayed during, before, or after a shave session, or in response to a user input, in the form of prompts. An input 32 may allow a user to respond to prompts displayed on display 30. Though only one input 32 is depicted, base 18 may include more than one input 32. Input 32 may be touch sensitive and/or may include voice-activation technology so that a user may speak commands to base 18. In one aspect, any one or all of the features discussed above with respect to base 18 may be incorporated into one or both of handle 14 or user device 20. For example, although not shown, handle 14 may further include a display and/or user input buttons or switches. In some aspects, all of the functionality provided by base 18 may be incorporated into handle 14, and base 18 may be omitted altogether. In such aspects, shaver 12 may be configured to directly transmit to and receive information from user device 20 and/or merchant unit 22 via, e.g., the Internet. Moreover, if base 18 is omitted, charging of handle 14 may be performed using a wired (not shown) or wireless system, e.g., through induction.

User device 20 may include a smartphone, tablet, smartwatch, computer, or other device that may run a downloadable application or an application accessed via the Internet. The application may include, for example, a user interface for system 10. The application may be configured to receive information from and send information to the other parts of system 10. The application may include one or more software elements to receive, process, and/or generate information. Any one or all of the features associated with user device 20 may be incorporated into one or both of shaver 12 of base 18.

User device 20 may also include an imaging sensor (not shown). The imaging sensor may be an electro-optical sensor, such as a camera, or other device now known or later developed, which is capable of acquiring two-dimensional (2-D), for example a 2D camera, and/or three-dimensional (3-D) images of a user, for example a 3D camera, e.g., a face of the user, the user's surrounding, and/or shave system 10. The imaging sensor may be capable of acquiring images automatically according to a shaving program, or a user may input a request to acquire an image via, e.g., an audio or touch input to user device 20. Alternatively, or additionally, the user may input an image acquiring request to system 10 via, e.g., shaver 12 via a touch or audio request.

In some embodiments, a prior-captured image may be uploaded or otherwise provided to system 10 via user device 20. For example, prior to shaving, a user may select a photograph of his or her face stored in user device 20 and the photograph may be uploaded to system 10. As will be described in greater detail herein, the photograph may be used to program or otherwise determine a preferred angle range of cartridge 16 to handle 14 of shaver 12 during a shave.

An enlarged view of shaver 12 is shown in FIG. 2. Shaver 12 includes handle 14 and cartridge 16, with cartridge 16 having one or more blades 34 for cutting hair. Shaver 12 may also include one or more sensors 36. For example, shaver 12 may include a grid of sensors 36 that may take multiple measurements simultaneously and/or by different means. Sensors 36 may be disposed on any suitable surface of cartridge 16 and/or handle 14 capable of determining a position and/or angle of shaver 12, including, but not limited to, a position and/or pivot angle (e.g., angle) of cartridge 16 relative to handle 14. Measurements may be made by sensors 36 once prior to and/or during a shaving session, repeatedly at one or more time intervals during a shaving session, or continuously during a shaving session or even before or after a shaving session. Further, measurements by sensors 36 may be made automatically according to, e.g., a shave program, or by a request via a user input. For example, sensors 36 may capture one or more images of a face of the user. The one or more images may be used by shaver 12 and/or may be transmitted to system 10. As will be described in greater detail herein, the photograph may be used to program or otherwise determine a preferred pivot angle range of cartridge 16 to handle 14 of shaver 12 during a shave.

According to an example, a sensor 36 may include an electro-optical sensor, e.g., a camera, capable of acquiring two-dimensional (2-D) and/or three-dimensional (3-D) images of a user, e.g., a face of the user. Sensor 36 may be placed on any suitable surface of shaver 12 including on handle 14 and/or cartridge 16, and may be configured to provide an image of a user. Sensor 36 may acquire multiple images of the user over time, including video images of a user, and compare these images to each other to determine a pivot angle and/or a change in pivot angle of cartridge 16 relative to handle 14.

Additional aspects of an imaging sensor of system 10, e.g., electro-optical sensor 36, are described below. It should be understood that each of sensors 36 on shaver 12 may be the same or similar to sensor 36. Sensor 36 may be electrically coupled to a power source in handle 14, such as an internal battery, via one or more electrically-conductive wires and/or contacts. In one aspect, sensor 36 may include a light source and a receiver. The light source may emit light onto the skin of the user. The light source may include a light emitting diode (LED), such as a red light emitting LED, a green light emitting LED, an infrared radiation emitting LED, or any other suitable light emitter, LED or otherwise. Alternatively, or additionally, sensors 36 may include one or more additional sensors including, but not limited to, a strain gauge, an accelerometer, a displacement sensor, a temperature sensor, a pressure sensor, a piezoelectric sensor, a magnetic sensor, an electromagnetic sensor, and/or a gyroscope. Use of these additional sensors will be described in greater detail herein.

Upon obtaining an image or video of a face of the user using imaging sensors associated with user device 20 and/or shaver 12, the image or video may be transmitted to a user device 20 and/or merchant unit 22 via any suitable connection 24, e.g., the Internet. As will be described herein in greater detail, the image and/or video may identify a shave area and/or parameters of the shave area. This information may be transmitted from user device 20 and/or merchant unit 22 to any of shaver 12, base 18, and/or user device 20 via any suitable connection to provide feedback (e.g., an error signal) to a user, as described in greater detail herein.

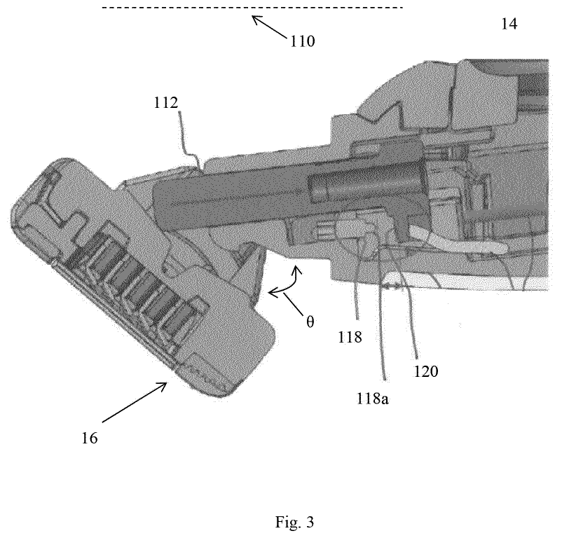

Referring to FIG. 2, cartridge 16 may be configured to pivot relative to handle 14. For example, a biasing element 112, such as a pusher or pivot tongue (shown in FIG. 3), disposed at distal end portion 106 of handle 14 may translate back and forth along longitudinal axis 110 or up and down with respect to the longitudinal axis 110, thereby allowing shaving cartridge 16 to rotate with respect to handle 14 about transverse axis 130 (as shown in FIG. 2). Biasing element 112 may include mating features that engage a corresponding guide (not shown) (e.g., a track, groove, or recess) in cartridge 16. Biasing element 112 may be biased toward distal end portion 106 by a spring or other resilient member (not shown). The distally directed bias of biasing element 112 may bias cartridge 16 into a rest position shown in FIG. 3. While shaver 12 is in use, biasing element 112 may be subject to a proximally-directed force (e.g., from a face of the user), and may move proximally along the corresponding guide (not shown), thereby causing cartridge 16 to rotate or otherwise pivot with respect to handle 14. In addition, as those of ordinary skill in the art may recognize, cartridge 16 may be configured to rotate in the clockwise and counterclockwise directions (e.g., as indicated by the double-headed arrow associated with the pivot angle θ).

Referring to FIG. 3, biasing element 112 may include a first electrical contact 118 (e.g., a conductive pin) and a second electrical contact 120. In one example, biasing element 112 may be formed of a plastic or otherwise non-metal or non-conductive material. In this example, second electrical contact 120 may be a conductive material (e.g., a conductive pin) attached to the outer surface of, or extending from the non-conductive biasing element 112. In another example, biasing element 112 may be formed of metal or another conductive material, and biasing element 112 itself may act as second electrical contact 120.

First electrical contact 118 may be fixed on or within handle 14 (by, e.g., a weld, adhesive, mechanical, or other suitable mechanism) at or adjacent distal end 106 of shaver 12. Second electrical contact 120 may be coupled (by, e.g., a weld, adhesive, mechanical, or other suitable mechanism) to a distally facing portion of biasing element 112 (e.g., a flange protruding radially outward or otherwise depending from a remainder of biasing element 112). With continued reference to FIG. 3, first electrical contact 118 is depicted with a proximally-extending protrusion 118A. In some embodiments, protrusion 118A may be configured to be telescopingly withdrawn into a remainder of first electrical contact 118.

In such embodiments, biasing element 112 may also be configured to measure a force applied by first electrical contact 118 onto second electrical contact 120 in embodiments where, for example, the first and second electrical contacts 118 and 120 are spring loaded. In some alternatives, biasing element 112 may be replaced with a piezoelectric sensor to measure a force, thereby providing a pivot angle θ between handle 14 and cartridge 16 based on the measured force. In other embodiments, biasing element 112 may be associated with one or more additional sensors including, but not limited to, a strain gauge, an accelerometer, a displacement sensor, a temperature sensor, a pressure sensor, and a gyroscope. For example, biasing element 112 may include a spring (not shown) that may be compressed and/or expanded to measure a force on the cartridge 16. These additional sensors may aid in determining and/or verifying pivot angle θ of cartridge 16 to handle 14, as calculated by a displacement of biasing element 112, discussed in greater detail herein.

It has been determined that a shave condition may be affected by pivot angle θ of cartridge 16 to handle 14. According to an embodiment, optimizing pivot angle θ of cartridge 16 relative to handle 14 through, e.g., an algorithm or experimental data, may improve the quality of a user's shave. Accordingly, determining pivot angle θ and alerting a user when pivot angle θ does not satisfy a desired angle range associated with a quality shave may be performed.

For example, with reference to Table 1, a displacement of biasing element 112 may be translated into an angle of rotation of cartridge 16 about transverse axis 130. It will be understood that the values provided in Table 1 are in no way intended to limit the scope of the embodiments disclosed herein. As shown in Table 1, a displacement distance of biasing element 112 from a rest position, e.g., the biased position of cartridge 16 shown in FIG. 3, during shaving may be obtained. For example, biasing element 112 may include notches or markings (not shown) and a camera (not shown) may take images of the markings or notches to determine a displacement of biasing element 112. According to another embodiment, a distance of withdrawal of protrusion 118A into first electrical contact 118 may correspond to displacement of biasing element 112, which, in turn, may be used to calculate pivot angle θ of cartridge 16. The distance of withdrawal may be similarly determined by imaging notches or markings (not shown) on protrusion 118A and comparing the images.

TABLE 1
Pivot angle of cartridge based on displacement
distance of biasing element

| | | Pusher | |
|---|---|---|---|
| | | Displacement | Spring |
| | | from Head's | Compression |
| | Deg. | rest position | from Lo |
| | (°) | (mm) | (mm) |
| MIN | 0 | 0.000 | 1.57 |
| | 1 | 0.070 | 1.64 |
| | 2 | 0.130 | 1.70 |
| | 3 | 0.190 | 1.76 |
| | 4 | 0.250 | 1.82 |
| | 5 | 0.310 | 1.88 |
| | 6 | 0.360 | 1.93 |
| | 7 | 0.420 | 1.99 |
| | 8 | 0.470 | 2.04 |
| | 9 | 0.510 | 2.08 |
| | 10 | 0.560 | 2.43 |
| | 11 | 0.600 | 2.47 |
| | 12 | 0.650 | 2.22 |
| | 13 | 0.700 | 2.27 |
| | 14 | 0.750 | 2.32 |
| | 15 | 0.800 | 2.37 |
| | 16 | 0.850 | 2.42 |
| | 17 | 0.900 | 2.47 |
| | 18 | 0.950 | 2.52 |
| | 19 | 1.000 | 2.57 |
| | 20 | 1.050 | 2.62 |
| | 21 | 1.110 | 2.68 |
| | 22 | 1.160 | 2.73 |
| | 23 | 1.210 | 2.78 |
| | 24 | 1.270 | 2.84 |
| | 25 | 1.330 | 2.90 |
| | 26 | 1.380 | 2.95 |
| | 27 | 1.440 | 3.01 |
| | 28 | 1.500 | 3.07 |
| | 29 | 1.560 | 3.43 |
| | 30 | 1.620 | 3.49 |
| | 31 | 1.680 | 3.25 |
| | 32 | 1.750 | 3.32 |
| | 33 | 1.810 | 3.38 |
| | 34 | 1.870 | 3.44 |
| | 35 | 1.940 | 3.51 |
| | 36 | 2.010 | 3.58 |
| | 37 | 2.070 | 3.64 |
| | 38 | 2.140 | 3.71 |
| | 39 | 2.210 | 3.78 |
| MAX | 40 | 2.280 | 3.85 |

Referring to Table 1, pivot angles θ of cartridge 16 with respect to handle 14 are shown based on a displacement distance of biasing element 112. Using pivot angles θ in Table 1, a desired pivot angle θ for providing a quality shave may be determined. For example, the desired pivot angle θ may be a range between approximately 0 degrees and approximately 25 degrees. The desired pivot angle θ may change based on the type of shave a user desires, e.g., a close shave, or based on the gender of the user, and may be determined automatically or by a user input. According to an embodiment, the desired angle range may be smaller for shaving areas having sensitive or oily skin. Alternatively, or additionally, the upper limit of the angle range may be greater for shaving areas in which the skin is rough and/or the hair to be shaved is coarse.

For example, shaver 12 may be used on individuals with different body features, e.g., the contour of a user's facial features, different skin sensitivities, different shaving preferences, different moisture characteristics, etc. A user may select various parameters for a shave, such as a close shave performed on a “normal” face, e.g., average skin texture and average hair coarseness. Based on this input, the processor may set a pivoting range of shaver 12 based on programs saved in a memory of shaver 12 and/or transmitted to shaver 12 from a remote device, such as base 18, user device 20, and/or merchant unit 22. According to an example, the shaving area may be continuously checked during a shave using, e.g., sensors 36. If the shave area changes such that the parameters change, e.g., a contour of the face changes, the desired angle range may also change throughout the shave. For example, system 10 may automatically send a program to shaver 12 to change the desired angle range based on, e.g., an image of the shaving area obtained by sensors 36.

System 10 may include and/or obtain from, e.g., the Internet, a shave program based on a desired shave, e.g., a close shave, and shaver 12 could determine pivot angle θ based on the specific contours of the user's face. For example, a user may select a desired shave through an input into shaver 12, base 18, and/or device 20. Alternatively, or additionally, system 10 may receive an image of an area to be shaved, e.g., a face of a user. As discussed herein, the image may be uploaded or obtained from device 20 and/or may be obtained using one or more sensors 36. Based on the user selection and/or the image obtained by system 10, contours of the body area to be shaved, skin type, and/or hair type may be identified, and a desired pivot angle for the user may be provided to system 10. For example, as discussed herein, if an image includes an area of the body having sensitive skin and fine hair, a desired angle range may be approximately 0 degrees and approximately 25 degrees. By shaving within a desired angle range (e.g., a predetermined desired angle range), cartridge 16 and handle 14 may be provided at the optimum range to deliver, e.g., a minimum force exertion on a user's skin, provide the closest shave with minimal skin irritations, and/or minimize hand and joint fatigue by offering an ergonomically improved shave.

During shaving, shaver 12 may continuously or periodically determine pivot angle θ of cartridge 16 and/or handle 14 about transverse axis 130 as described herein. When pivot angle θ is outside the desired angle range, an error signal (or other feedback) may be generated, e.g., an audio, visual, or haptic feedback from shaver 12, base 18, or a mobile application associated with user device 20. It will be understood, however, that rotating pivot angle θ outside the desired angle range does not deter or impede the ability of shaver 12 to continue to be used for normal shaving activities. It will also be understood that once pivot angle θ is back within the predetermined shave range, the error signal may be turned off. Alternatively, or additionally, the error signal may consist of one or more instructions to the user to improve the shaving condition, such as but not limited to, providing a visual or audio command for operating shaver 12.

With renewed reference to FIG. 2, the warning error may be, for example, in the form of flashing lights 40, 42, e.g., light emitting diodes (LEDs), an audio output, a haptic feedback from actuator 46, and/or a visual display on a display of handle 14 (not shown). It will be understood that these elements may be placed at any position on or around shaver 12 to provide the user with an error message. As those of ordinary skill in the art will recognize, these same or similar error outputs may be generated by base 18 and/or user device 20 by any now known or later developed device.

According to another embodiment, error signals may be generated so long as pivot angle θ between cartridge 16 and handle 14 is outside the desired angle range for more than a predetermined period of time. For example, if pivot angle θ is outside the desired angle range for a short period of time, e.g., approximately 1 to 2 seconds, no error signal is generated. However, if pivot angle θ is outside the desired angle range for a time greater than the predetermined time, e.g., approximately 2 seconds, an error signal may be generated, e.g., an audio, visual, or haptic feedback from shaver 12, base 18, or a mobile application associated with shaver 12 and provided on user device 20. Pivoting cartridge 16 about handle 14 such that pivot angle θ is outside the desired angle range for a time greater than the predetermined time may not deter or impede the ability of shaver 12 to continue to be used for normal shaving activities.

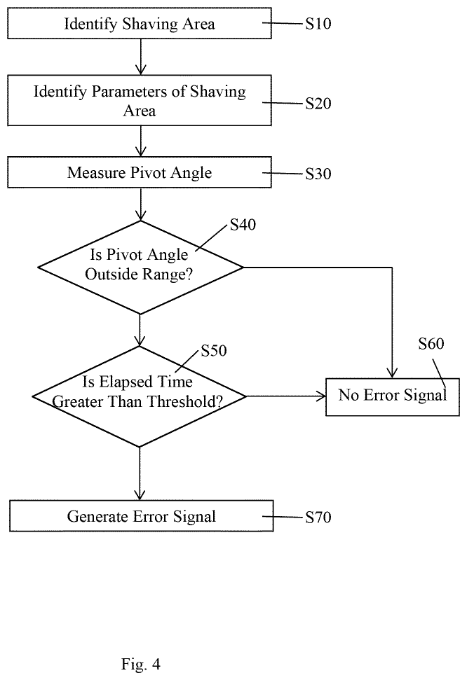

Referring to FIG. 4, a method for determining a shave pivot angle θ between cartridge 16 and handle 14 and alerting a user of a shave pivot angle θ will be described. It will be understood that one or more steps of the method described herein may be excluded. Alternatively, or additionally, method steps may be rearranged according to one or more inputs from a user or a shaving program.

As shown in Step S10, a shaving area is identified. The shaving area may be identified by, e.g., a user input to shaver 12, base 18, user device 20, an input from merchant unit 22, and/or a preset program. Alternatively, or additionally, the shaving area may be determined by sensor 36 and/or an imaging device associated with user device 20 when shaver 12 is placed in the shave area. The shave area may be determined using a face of the user and/or image or location data determined by sensor 36 and/or an imaging device associated with user device 20. For example, an image of a room in which a user is shaving, a location of shaver 12 in the room, and/or a location of the user in the room may be used to determine the shave area.

As shown in Step S20, parameters associated with the shaving area are identified such as, but not limited to, a contour of the shaving area, a type of hair (e.g., fine or coarse) associated with the shaving area, and a type of skin (e.g., soft or rough) associated with the shaving area. These parameters may be identified using the image of the shaving area obtained in Step S10. Identifying the contour of the shaving area and/or other parameters of the shaving area may allow shaving system 10 to determine a predetermined desired angle range of cartridge 16 to handle 14 as discussed herein. The predetermined desired angle range may be set to provide an optimal shave based on the parameters, e.g., skin type, hair coarseness, etc., associated with that shave area.

Pivot angle θ is calculated in Step S30. Pivot angle θ may be calculated by using, e.g., a displacement of biasing element 112, a gyroscope, a rotary sensor, or a linear sensor, etc. For example, as shown in Table 1, a displacement of biasing element 112 may be associated with a pivot angle θ between cartridge 16 to handle 14 about transverse axis 130.

In Step S40, system 10 compares pivot angle θ to a desired angle range greater than the desired angle range of cartridge 16 to handle 14 about transverse axis 130. It will be understood that the body area to be shaved and/or parameters associated with the body area to be shaved may identify the predetermined desired angle range. For example, an area of the body that has greater angular changes may have a greater predetermined desired angle range than an area of the body which does not have large contour changes. According to an embodiment, a desired angle range may be approximately 0 degrees to approximately 40 degrees, and more particularly approximately 0 degrees to approximately 25 degrees.

If pivot angle θ is greater than the predetermined desired angle range in Step S40, it may be identified in Step S50 whether pivot angle θ has been greater than the desired angle range for a predetermined time period, e.g., approximately 2 seconds. A timer (not shown) associated with system 10 may count the amount of time pivot angle θ has been greater than the predetermine time period. It will be understood that each time pivot angle θ is less than or equal to the predetermined time period, the timer is reset. It will be understood that Step S60 may be eliminated in certain embodiments. For example, in some embodiments, a method of shaving may notify a user immediately upon pivot angle θ being greater than the desired angle range. Accordingly, in some embodiments, a shaving method may proceed from Step S40 directly to Step S70, described below, if pivot angle θ is greater than the desired angle range.

In Step S60, if pivot angle θ is less than or equal to the desired angle range in Step S40, an error signal is not generated.

With continued reference to FIG. 4, if pivot angle θ is greater than the desired angle range and greater than the predetermined time threshold, an error signal (e.g., an output), may be generated in Step S70. According to some embodiments, the generated error signal may be, e.g., an audio, a visual, or an haptic feedback from shaver 12, base 18, and/or user device 20. However, rotating pivot angle θ outside the desired angle range does deter or impede the ability of shaver 12 to continue to be used for normal shaving activities, albeit with less than optimal results.

As is evident from the figures and text presented above, as well as the examples below, a variety of non-limiting embodiments are contemplated. In one embodiment, for example, a shaving system may include a shaver. The shaver may include a handle; a cartridge having at least one blade, the cartridge pivotably connected to the handle about an axis transverse to a longitudinal axis of the handle; a biasing element connected to the handle and connected to the cartridge, the biasing element being configured to move along the longitudinal axis of the handle in response to the cartridge pivoting; and a sensor configured to determine a pivot angle of the shaver cartridge relative to the handle; and a processor configured to receive information about the movement of the biasing element and determine an angle between the cartridge and the handle about the transverse axis based on the information.

Various embodiments of the shaving system may include one or more of the following features: the processor is configured to determine if the angle is greater than a predetermined angle range; the processor is configured to generate an alert in response to the angle being greater than the predetermined angle range; the alert is at least one of an audio response, a visual response, or a haptic response; one or more of a linear sensor, a rotary sensor, a magnetic sensor, an electromagnetic sensor, and a gyroscope; the biasing element includes one or more of notches and marks, and a displacement distance of the biasing element is calculated using the notches and/or marks.

In another embodiment, for example, a shaving method using a shaver may include identifying an area to be shaved. The method may include identifying parameters associated with the area to be shaved, measuring an angle between a handle of the shaver and a cartridge attached to the handle, determining if the angle is outside a predetermined angle range, and alerting a user in response to the angle being outside the predetermined angle range.

Various embodiments of the shaving method may include one or more of the following features: determining, in response to the angle being outside the predetermined angle range, if the angle is outside the predetermined angle range for a time greater than a predetermined time; alerting the user in response to the angle being outside the predetermined angle range greater than the predetermined time; identifying the shave area by imaging one or more of the user's face and the user's surroundings; and the predetermined angle range changes in response to a change in the area to be shaved.

The many features and advantages of the present disclosure are apparent from the detailed specification, and thus, it is intended by the appended claims to cover all such features and advantages of the present disclosure that fall within the true spirit and scope of the disclosure. Further, since numerous modifications and variations will readily occur to those skilled in the art, it is not desired to limit the present disclosure to the exact construction and operation illustrated and described, and accordingly, all suitable modifications and equivalents may be resorted to, falling within the scope of the present disclosure.

Moreover, those skilled in the art will appreciate that the conception upon which this disclosure is based may readily be used as a basis for designing other structures, methods, and systems for carrying out the several purposes of the present disclosure. Accordingly, the claims are not to be considered as limited by the foregoing description.

Technical and scientific terms used herein have the same meaning as commonly understood to one of ordinary skill in the art to which this disclosure belongs unless clearly indicated otherwise. As used herein the singular forms “a”, “an”, and “the” include plural references unless the context clearly dictates otherwise. Thus, for example, reference to “a sensor” may include a plurality of such sensors and reference to “the sensor” may include reference to one or more sensors and equivalents thereof known to those skilled in the art, and so forth.

The above description is illustrative and is not intended to be restrictive. One of ordinary skill in the art may make numerous modifications and/or changes without departing from the general scope of the disclosure. For example, and as has been described, the above-described embodiments (and/or aspects thereof) may be used in combination with each other. Additionally, portions of the above-described embodiments may be removed without departing from the scope of the disclosure. In addition, modifications may be made to adapt a particular situation or material to the teachings of the various embodiments without departing from their scope. Many other embodiments will also be apparent to those of skill in the art upon reviewing the above description.

1. A shaving system, comprising:
a shaver including:
a handle;
a cartridge having at least one blade, the cartridge pivotably connected to the handle about an axis transverse to a longitudinal axis of the handle; and
a biasing element connected to the handle and connected to the cartridge, the biasing element being configured to move along the longitudinal axis of the handle in response to the cartridge pivoting;
a sensor configured to determine a pivot angle of the shaver cartridge relative to the handle; and
a processor configured to receive information about the movement of the biasing element and determine an angle between the cartridge and the handle about the transverse axis based on the information.

2. The shaving system according to claim 1, wherein the processor is configured to determine if the angle is greater than a predetermined angle range.

3. The shaving system according to claim 2, wherein the processor is configured to generate an alert in response to the angle being greater than the predetermined angle range.

4. The shaving system according to claim 3, wherein the alert is at least one of an audio response, a visual response, or a haptic response.

5. The shaving system according to claim 1, further comprising one or more of a linear sensor, a rotary sensor, a magnetic sensor, an electromagnetic sensor, and a gyroscope.

6. The shaving system according to claim 1, wherein the biasing element includes one or more of notches and marks, and
a displacement distance of the biasing element is calculated using the notches and/or marks.

7. A shaving method using a shaver, comprising:
identifying an area to be shaved;
identifying parameters associated with the area to be shaved;
measuring an angle between a handle of the shaver and a cartridge attached to the handle;
determining if the angle is outside a predetermined angle range; and
alerting a user in response to the angle being outside the predetermined angle range.

8. The shaving method according to claim 7, further comprising:
determining, in response to the angle being outside the predetermined angle range, if the angle is outside the predetermined angle range for a time greater than a predetermined time; and
alerting the user in response to the angle being outside the predetermined angle range greater than the predetermined time.

9. The shaving method according to claim 7, wherein the shave area is identified by imaging one or more of the user's face and the user's surroundings.

10. The shaving method according to claim 9, wherein the imaging of one or more of the user's face and the user's surrounding is performed using a 2D camera.

11. The shaving method according to claim 9, wherein the imaging of one or more of the user's face and the user's surrounding is performed using a 3D camera.

12. The shaving method according to claim 7, wherein the predetermined angle range changes in response to a change in the area to be shaved.

13. The shaving method according to claim 7, wherein determining if the angle is outside a predetermined angle range corresponds to an angle that is greater than the predetermined angle range
